(19) United States
(12) Patent Application Publication
(10) Pub. No.: US 2002/0154499 A1
(43) Pub. Date: Oct. 24, 2002

(54) Screwdriver with an indicator bulb

(76) Inventor: Kai-Cheng Hsieh, Taipei City (TW)

Correspondence Address: KAI-CHENG HSIEH, P.O. BOX 7-820, TAIPEI, TW

(21) Appl. No.: 09/836,583

(22) Filed: Apr. 18, 2001

(51) Int. Cl. B25B 23/18

(52) U.S. Cl. 362/120; 362/119; 362/800

(57) ABSTRACT

This invention is about a screwdriver with an indicator bulb. There is a U-shaped fixation base on the front part of the handle of the screwdriver. Inside the fixation base is a semi-circular ring for the fixation of the indicator bulb base. In front and below the bulb base have a longitudinal slot and a mating semi-circular hole. Inside the slot and the hole is a rectangular slot for insertion and fixation of a LED bulb. In the middle of the rectangular slot is an embedded slot that allows connection to the battery container behind. A LED diode cable will pass through the embedded slot and go to the positive and negative electrodes of the battery in the battery container, supplying power for the indicator bulb, which provides illumination parallel to facilitate the screwdriver lock up operation. The bulb is turned on/off by pressing a press button.

### BACKGROUND OF THE INVENTION

In the face of the demand for versatile and sophisticated technological products and the space between related parts became narrower than before thus the design of screwdrivers is diversified. It is usually difficult to work with a screwdriver in holes which are poorly illuminated, such as a hole found deeply in an object, a hole in a cleft, or a hole inside big object, etc. For this reason, screws may not be fastened evenly, or they may be inserted in an oblique direction, causing hazards to users and consumers. Hence, the underlying problem is illumination. This invention is aimed to improve such kind of out-dated screwdrivers.

### SUMMARY OF THE INVENTION

The primary purpose of this invention is to provide a screwdriver with an indicator bulb. There is a U-shaped fixation base in the interior part of the handle of the screwdriver, for the fixation of the indicator bulb base and the connection to a battery, so that the area in front of the screwdriver is illuminated with a parallel light ray.

The secondary purpose of this invention is to provide a screwdriver with an indicator bulb. In front and below of the bulb base is a longitudinal slot and a neighboring semi-circular hole. Inside the slot and the hole is a rectangular slot for insertion and fixation of a LED bulb.

Another purpose of this invention is to provide a screwdriver with an indicator bulb. In the middle of the rectangular slot is an embedded slot that allows connection to the battery container behind. A LED diode cable will pass through the embedded slot and go to the positive and negative electrodes of the battery in the battery container for power supply.

Another purpose of this invention is to provide a screwdriver with an indicator bulb, which is convenient for users to follow the guidance of illumination and to work with screw holes which u0sed to be poorly illuminated.

### BRIEF DESCRIPTION OF THE DRAWINGS

FIG. 1 is a perspective view of the present invention;

FIG. 2 is a perspective exploded view of the present invention;

FIG. 3 is shows how to insert the indicator bulb into the fixation base;

FIG. 4 is a view compares the functions of this invention.

### DELTAILED DESCRIPTION OF THE PREFERRED EMBODIMENT

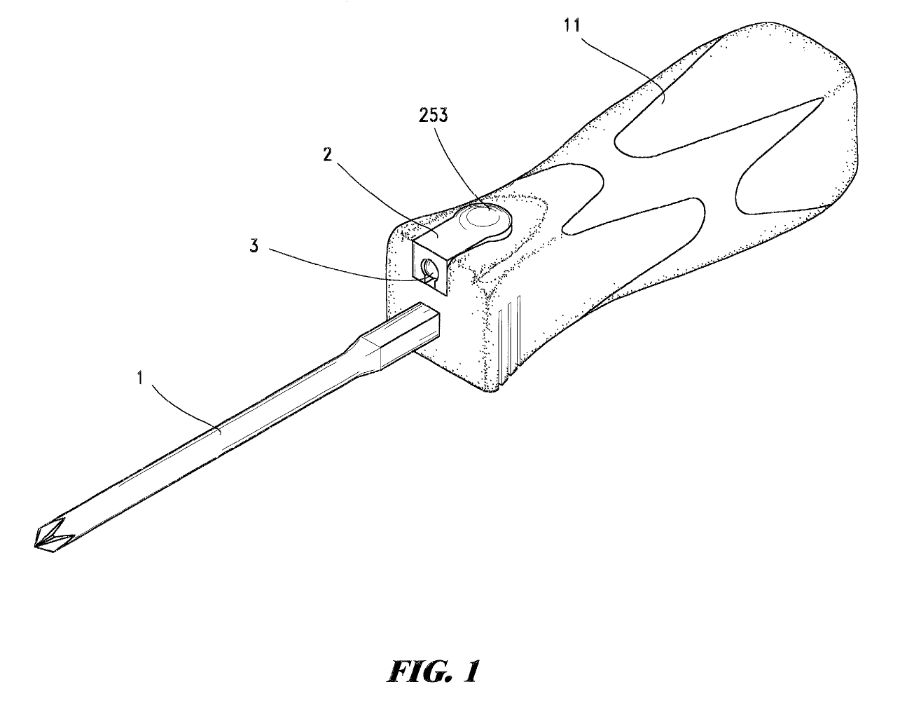

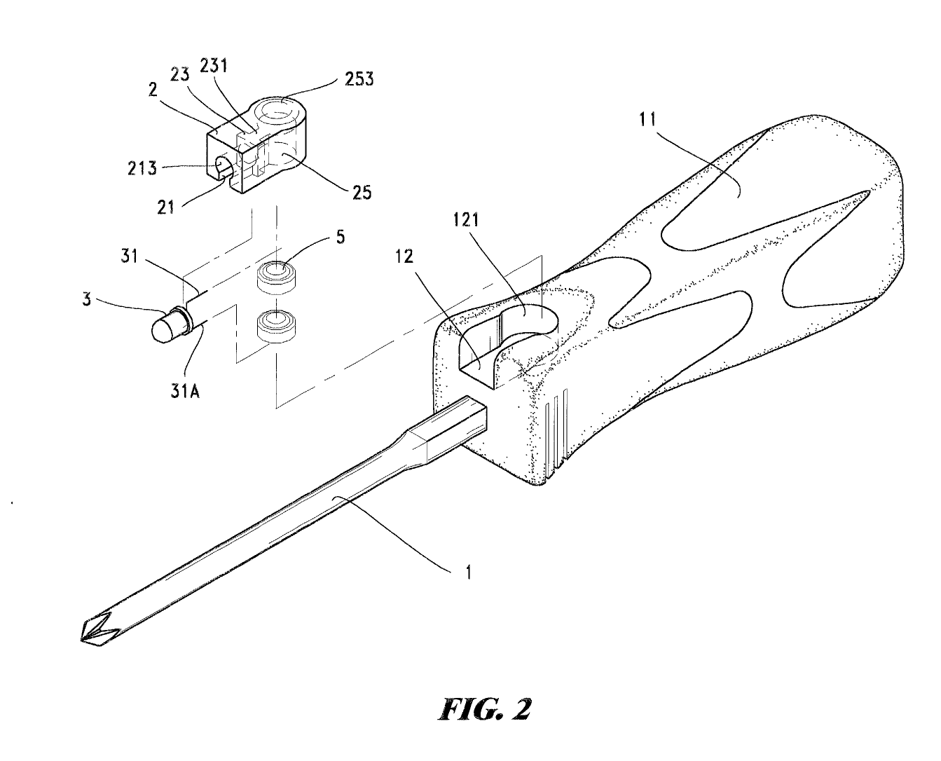

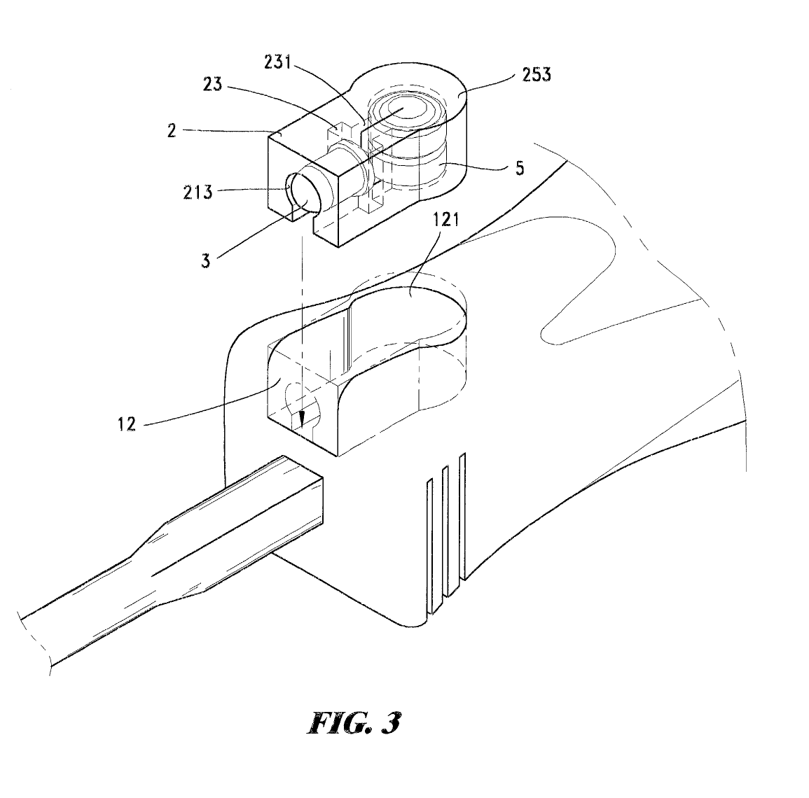

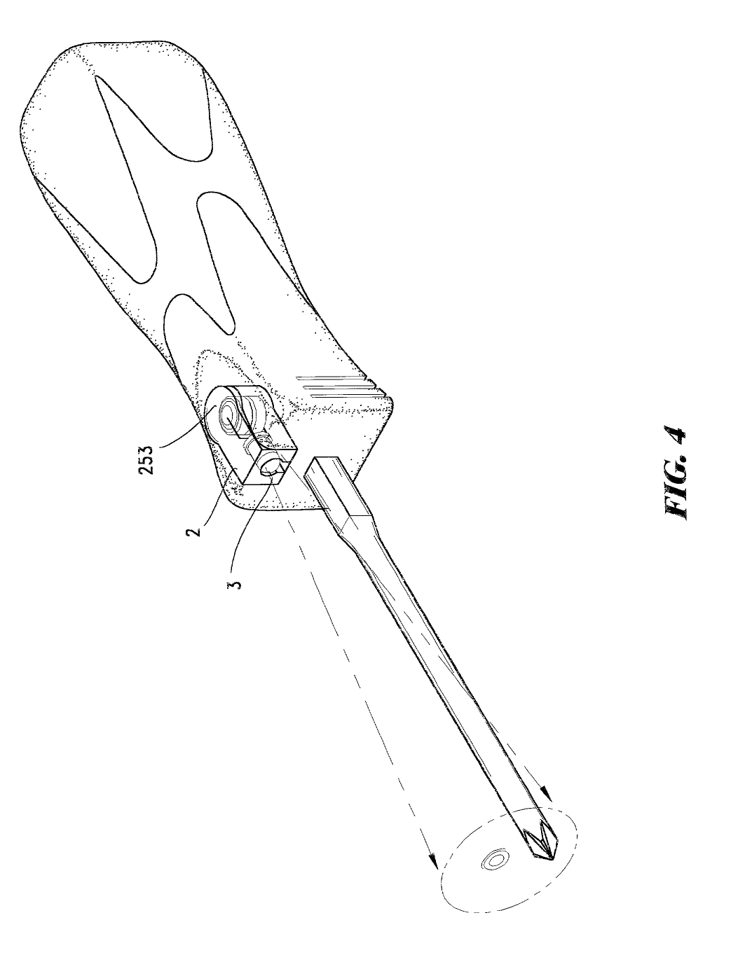

With reference to the drawings and in particular to FIGS. 1 through 4,in this invention, the indicator bulb screwdriver consists of screwdriver (1), indicator bulb base (2), LED bulb (3) and battery (5). There is a U-shaped fixation base (12) in the interior part of the handle (11) of the screwdriver (1). In the bottom of the fixation base is a semi-circular ring (121). The indicator bulb base (2), which matches the fixation base (12), is made from plastic. In front and below of the bulb base is a longitudinal slot (21) and a neighboring semi-circular hole (213). Inside the slot and the hole is a slightly bigger rectangular slot (23) cut through by the longitudinal slot in a transverse way. In the middle of the rectangular slot is an embedded slot (231) that allows connection to an arc-shaped battery container (25) behind. Right above the battery container, is an arc-shaped press button (253) found on a prominence of the surface of the bulb base. A diode cable (31, 31A) of the LED bulb (3) is connected to the positive and negative electrodes of a battery (5), so that the LED is inserted into the semi-circular hole (213) by passing through the longitudinal slot (21). The diode cable (31, 31A) of the LED bulb (3) passes through the rectangular slot (231) and is connected to the positive and negative electrodes of a battery (5), which lies in the battery container (25). As a result of these structures, the indicator bulb base (2) is well inserted into the fixation base (12), which is the primary structure of the invention.

In this invention, the LED diode cable (31, 31A) is pressed by pressing the arc-shaped press button (253), so that power is supplied by the battery (5), and thus the area in front of the screwdriver is illuminated by a parallel light ray and working with poorly illuminated screw holes can be efficient.

It is to be understood that the present invention is not limited to the sole embodiment described above, but encompasses any and all embodiments within the scope of the followin claims:

I claim:

1. The indicator bulb screwdriver consists of a screwdriver, an indicator bulb base, a LED bulb and a battery,
A screwdriver, with the interior part of its handle holds a fixation base. In the bottom of the fixation base is a semi-circular ring;
An indicator bulb base, which matches the fixation base, is made from plastic. In front and below the bulb base is a longitudinal slot. The bottom of the longitudinal slot is connected to a semi-circular hole. Inside the slot and the hole is a slightly bigger rectangular slot cut through by the longitudinal slot in a transverse way. In the middle of the rectangular slot is an embedded slot that is connected to an arc-shaped battery container behind. Right above the battery container is an arc-shaped press button found on a prominence of the surface of the bulb base;
A LED bulb, of which a diode cable passes through an embedded slot and be connected to the positive and negative electrodes of the battery in the battery container, is inserted into the semi-circular hole by passing through the longitudinal slot;
A battery;
The LED diode cable is pressed by pressing the arc-shaped press button, so that power is supplied by the battery, and thus the area in front of the screwdriver is illuminated by a parallel light ray and working with poorly illuminated screw holes can be efficient.
